(19) United States
(12) Patent Application Publication
(10) Pub. No.: US 2026/0031706 A1
(43) Pub. Date: Jan. 29, 2026

(54) PWM WAVE GENERATION DEVICE, DCDC CONVERTER CONTROL DEVICE, PWM WAVE GENERATION METHOD, AND DCDC CONVERTER CONTROL METHOD

(71) Applicant: Panasonic Intellectual Property Management Co., Ltd., Osaka (JP)

(72) Inventors: Naganori SHIRAKATA, Osaka (JP); Yuji AOKI, Osaka (JP); Shingo SHIBUSAWA, Nara (JP)

(21) Appl. No.: 18/993,443

(22) PCT Filed: Jul. 26, 2023
(86) PCT No.: PCT/JP2023/027452

§ 371 Date: Jan. 10, 2025

(30) Foreign Application Priority Data
Jul. 27, 2022 (JP) 2022-119572

(51) Int. Cl. H02M 1/088; H02J 7/34; H02M 1/00; H02M 1/14; H02M 3/157; H02M 3/158

(52) U.S. Cl. CPC H02M 1/088; H02J 7/342; H02J 7/345; H02M 1/0009; H02M 1/143; H02M 3/157; H02M 3/1582; H02J 2207/50; H02J 2310/40

(57) ABSTRACT

One embodiment of the present disclosure comprises a PWM setting unit, a random number generation unit, a variation amount generation unit, an addition unit, a counter unit, and a comparison unit in order to generate a PWM wave for each given cycle and increase or decrease an on period for each PWM wave such that the duty ratio of the PWM wave is held when seen in a control cycle which is two or more given cycles.

### TECHNICAL FIELD

The present disclosure relates to a pulse width modulation (PWM) wave generation device, a direct current to direct current (DCDC) converter control device, a PWM wave generation method, and a DCDC converter control method.

### BACKGROUND ART

Vehicle power supply devices use a switching power supply with high accuracy, while taking measures to prevent electromagnetic interference (EMI) of a large number of electronic devices used in the vehicle.

In a DCDC converter using a switching method that excels in conversion efficiency, the on-off time ratio (duty ratio) of a semiconductor switch is controlled by a PWM signal to perform voltage boost/buck.

As a method for reducing such switching noise, there is a spread spectrum (hereinafter referred to as “SS”) technique in which the switching frequency is varied to disperse noise energy.

In the related art, a technique for performing SS by varying the carrier frequency of a PWM wave to reduce harmonic noise is known (see, for example, PTL 1).

### CITATION LIST

### Patent Literature

### PTL 1

Japanese Patent Application Laid-Open No. 2009-296849

### SUMMARY OF INVENTION

### Technical Problem

Through accurate control of the duty ratio, control of a device such as control of a switching power source including a highly accurate DCDC converter is performed, and such hardware PWM control is also utilized in the form of a dedicated IC.

However, with the recent electrification and electronization of vehicles, flexible software control using a CPU (Central Processing Unit) is employed for PWM control in order to perform complex control corresponding to driving conditions and equipment usage in backup power supplies for vehicles.

With embedded software that executes multiple functions, applications, or subroutines in real time, the scheduling becomes complicated when the processing time for each process varies.

In a case where a PWM wave is generated by software, the generation processing time varies when the carrier frequency is varied, which may affect the execution time of subroutines of other functions.

An object of a non-limiting embodiment of the present disclosure is to provide a PWM wave generation device, a DCDC converter control device, a DCDC converter, a PWM wave generation method, a DCDC converter control method, and a program in which software control is performed such that the generation processing time does not vary, the duty ratio of a PWM wave is held for each control cycle, and a spectrum-spread PWM wave is generated.

### Solution to Problem

A pulse width modulation wave generation device according to an embodiment of the present disclosure includes: a counter circuit that generates a count value that is reset for each constant cycle: a threshold value generation circuit that generates an initial threshold value; a variation amount generation circuit that generates a variation amount such that a sum of variation amounts for each control cycle including two or more of the constant cycles is 0; and a comparison circuit that compares a value based on the count value with a threshold value based on the initial threshold value and generates a pulse width modulation wave based on the variation amount.

A pulse width modulation wave generation method according to an embodiment of the present disclosure includes: generating a count value that is reset for each constant cycle: generating an initial threshold value: generating a variation amount such that a sum of variation amounts for each control cycle including two or more of the constant cycles is 0; and comparing a value based on the count value with a threshold value based on the initial threshold value, and generating a pulse width modulation wave based on the variation amount.

These comprehensive or specific aspects may be realized in a system, device, method, integrated circuit, computer program, or recording medium, or in any combination of a system, device, method, integrated circuit, computer program, and recording medium.

### Advantageous Effects of Invention

According to the embodiment of the present disclosure, it is possible to improve the spectrum spreading effect while simplifying the retention of the duty ratio of a PWM wave.

Further advantages and effects of one example of the present disclosure will be apparent from the specification and drawings. Such advantages and/or effects are provided by several embodiments and features described in the specification and drawings, respectively, but not necessarily all of them in order to obtain one or more identical features.

### BRIEF DESCRIPTION OF DRAWINGS

FIG. 1 is a configuration diagram illustrating an example of a DCDC converter device according to an embodiment of the present disclosure;

FIG. 2 is a diagram illustrating an example of a functional configuration of a CPU according to the embodiment of the present disclosure;

FIG. 3 is a timing diagram illustrating an example of PWM signal generation according to the embodiment of the present disclosure;

FIG. 4A is a flowchart illustrating an example of boost/buck control PWM signal generation according to the embodiment of the present disclosure;

FIG. 4B is a flowchart illustrating an example of boost/buck control PWM signal generation according to the embodiment of the present disclosure;

FIG. 5 is a timing diagram illustrating an example of spectrum spread PWM signal generation according to the embodiment of the present disclosure;

FIG. 6A is a diagram illustrating an example of a time waveform of a PWM wave according to the embodiment of the present disclosure;

FIG. 6B is a diagram illustrating an example of a time waveform of a PWM wave according to the embodiment of the present disclosure;

FIG. 6C is a diagram illustrating an example of a spectrum of a PWM wave according to the embodiment of the present disclosure;

FIG. 6D is a diagram illustrating an example of a spectrum of a PWM wave according to the embodiment of the present disclosure;

FIG. 7 is a block diagram illustrating an example of a random number generator according to the embodiment of the present disclosure

FIG. 8 is a diagram illustrating an example of a superimposed variation series according to the embodiment of the present disclosure; and

FIG. 9 is a diagram illustrating another example of the functional configuration of the CPU according to the embodiment of the present disclosure.

### DESCRIPTION OF EMBODIMENTS

The following is a detailed description of the embodiments of the present disclosure with reference to the drawings. The embodiments described below are examples, and the disclosure is not limited to the following embodiments.

The following is a detailed description of the embodiment of the present disclosure, referring to the drawings as appropriate. However, more detailed explanations than necessary may be omitted. For example, detailed explanations of matters already well known or duplicate explanations for substantially identical configurations may be omitted. This is to avoid unnecessary redundancy in the following explanations and to facilitate the understanding of those skilled in the art.

The accompanying drawings and the following description are provided to enable those skilled in the art to fully understand the disclosure, and are not intended to limit the subject matter recited in the claims.

### Embodiment 1

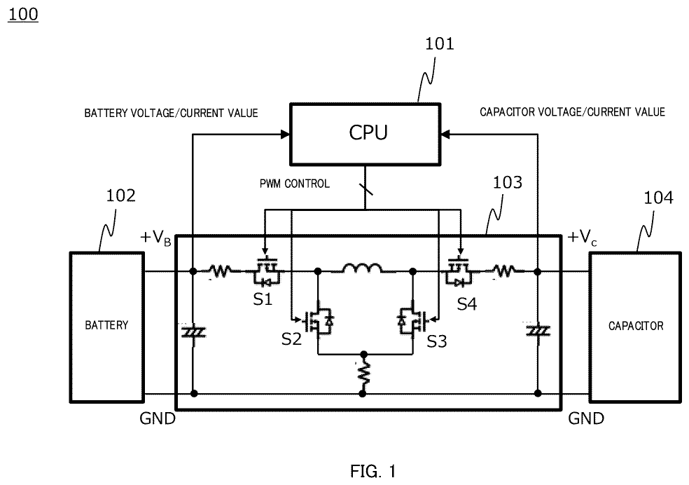

First, DCDC converter device 100 according to the embodiment of the present disclosure will be described with reference to FIG. 1. As illustrated in FIG. 1, DCDC converter device 100 includes CPU 101, battery 102, DCDC converter (boost/buck) circuit 103, and capacitor 104.

In the event of a voltage drop in battery 102 or the like, DCDC converter device 100, serving for example as an on-board power system, adjusts the voltage from capacitor 104, which is a storage device for an auxiliary power source, by using DCDC converter (boost/buck) circuit 103 and supplies power to a load (equipment to be connected not illustrated in the drawing).

CPU 101 monitors the voltage and current values of battery 102 and the voltage and current values of capacitor 104, and controls DCDC converter circuit 103 such that charging from battery 102 to capacitor 104 and discharging from capacitor 104 to battery 102 or a load are performed at a predetermined voltage and current.

Battery 102 is an on-board battery. A motor, an engine starter, and the like are connected to battery 102.

DCDC converter circuit 103 performs boost/buck of a direct current voltage by a switching method. DCDC converter circuit 103 turns semiconductor switches S1 to S4 on/off by the PWM wave control signal from CPU 101 to perform voltage conversion by the LC circuit. Further, DCDC converter circuit 103 detects the battery voltage/current value at the connector with battery 102, outputs the battery voltage/current value to CPU 101, detects the battery voltage/current value at the connector with capacitor 104, and outputs the capacitor voltage/current value to CPU 101.

Capacitor 104 is connected to auxiliary equipment, an ECU (Engine Control Unit), or the like, which operates with a smaller current than the equipment connected to battery 102. Capacitor 104 performs charging and discharging with battery 102 to back up the voltage variation of battery 102.

Note that for example, a large-capacity electric double-layer capacitor capable of rapid charging and discharging is used as capacitor 104 serving as a power storage element for storing power. Capacitor 104 may be a capacitor other than an electric double-layer capacitor, or may be a power storage element other than a capacitor, such as a flywheel.

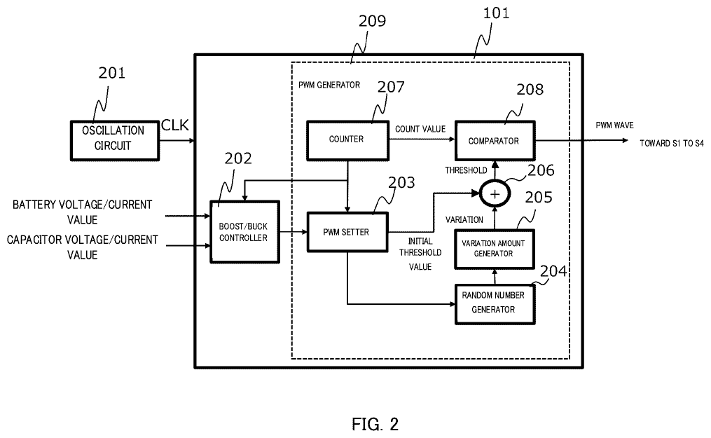

As illustrated in FIG. 2, CPU 101 includes boost/buck controller 202, PWM setter 203, random number generator 204, variation amount generator 205, adder 206, counter 207, and comparator 208. An operation clock (CLK) is supplied to CPU 101 from oscillation circuit 201. PWM setter 203, random number generator 204, variation amount generator 205, adder 206, counter 207, and comparator 208 may constitute PWM generator 209. Further, PWM setter 203 may constitute a threshold value generator that generates the initial threshold value of comparator 208.

Note that boost/buck controller 202, PWM setter 203, random number generator 204, variation amount generator 205, adder 206, counter 207, and comparator 208 are constituted by hardware or software. For example, counter 207 and comparator 208 may be implemented in hardware as a timer circuit and a comparator, respectively.

Boost/buck controller 202 calculates the boost/buck control value of DCDC converter circuit 103 based on the counter reset timing from counter 207, the input from other controllers (not illustrated in the drawing) (for example, the timing of startup, ignition ON, and the like), and the battery voltage/current value and the capacitor voltage/current value input from the outside, and outputs to PWM setter 203 the command values to be given to switches S1 to S4 of DCDC converter circuit 103. As an example, the calculation is an operation with a real number using a floating point.

PWM setter 203 converts the command value set by the boost/buck controller 202 into an on-count value (initial threshold value) corresponding to the on-period of a PWM wave corresponding to cycle T, based on the counter reset timing from counter 207. As an example, the on-count value is an integer. The on-count value is output to adder 206. Further, PWM setter 203 sets an initial value for random number generation in random number generator 204 and outputs an update timing for each control cycle including two or more periods. Further, PWM setter 203 sets the control cycle (predetermined interval) of the variation amount and the code series in variation amount generator 205.

After the initial value is set, random number generator 204 generates a random number series based on the update timing from PWM setter 203 and outputs the generated random number series to variation amount generator 205.

Variation amount generator 205 generates a variation amount series by multiplying the random number series from random number generator 204 by a predetermined code series, and outputs the variation amount series to adder 206. At this time, variation amount generator 205 determines the code series such that the duty ratio is held in a predetermined interval (control cycle) including two or more cycles T.

The code series is a series in which the selected basic code series is repeated. It suffices that the basic code series is set as a series with a sum of 0 and a length corresponding to the control cycle. In a case where the length of the basic code series is an even number, the basic code series may be a series in which the same number of +1 and −1 are set, such as {+1, −1} for a case of length 2 and {+1, +1, −1, −1} for a case of length 4.

In a case where the length of the basic code series is an odd number, the basic code series may be a series using coefficients such as {+1, +1, −2} such that the sum is 0. Note that coefficients may be used as {+1, +1, +1, −3} even in a case where the length is an even number.

Adder 206 generates a variation on-count value varied for each cycle T by adding each variation amount of the variation amount series to the on-count value output from PWM setter 203 for each cycle T. The variation on-count value is output to comparator 208 as a threshold value.

Here, when the variation amount added to the on-count value exceeds the range of the count value of the cycle T (when the value is larger than the maximum count value or is smaller than the minimum count value), the adder 206 does not add the variation amount to the on-count value and outputs the on-count value as it is. Note that when the variation amount added to the on-count value exceeds the range of the count value of the cycle T (when the value is larger than the maximum count value or is smaller than the minimum count value), variation amount generator 205 may set the variation amount to 0. Alternatively, the random number value or the code series may be set to 0.

Counter 207 repeats an operation of incrementing the count value in the clock cycle and resetting the count value at the maximum count value corresponding to cycle T. The count value is output to comparator 208. Note that counter 207 may repeat an operation of decrementing the count value in the clock cycle and resetting the count value to the maximum count value at the minimum count value corresponding to cycle T. Counter 207 outputs the counter reset timing to boost/buck controller 202 and PWM setter 203 at the timing of the reset, generates an interrupt, and activates the counter interrupt routine.

Comparator 208 compares the count value of counter 207 with the variation on-count value generated by adder 206, and generates a PWM wave by outputting an H level (on) for the count value less than the variation on-count value, and an L level (off) for the count value equal to or greater than the variation on-count value. Note that comparator 208 may output an H level (on) for the count value equal to or greater than the variation on-count value, and an L level (off) for the count value less than the variation on-count value, thereby generating a PWM wave.

In this manner, the PWM wave generated from the command value given to each switch of DCDC converter circuit 103 is input to DCDC converter circuit 103. The PWM wave input to DCDC converter circuit 103 controls switches S1 to S4, thereby controlling the charge and discharge and the boost/buck between battery 102 and capacitor 104.

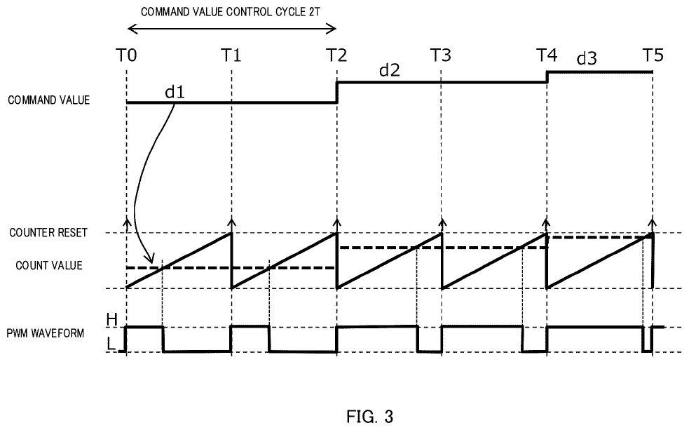

First, as a basic operation, the following describes with reference to FIG. 3 a case where PWM generator 209 generates a PWM wave without performing SS on the command value from boost/buck controller 202. This corresponds to an operation of turning off the operation of random number generator 204 and setting the variation amount generated by variation amount generator 205 to zero such that PWM generator 209 outputs a PWM wave with the on-count value input from PWM setter 203 as the threshold value.

The command value is, for example, a real number value of 0.0 to 1.0 that commands the ratio (duty ratio) of a period in which a predetermined switch is turned on within a control cycle (for example, 2T). The command value is latched (held) for each counter reset timing, for example.

Counter 207 increments the count value in clock cycles and outputs the count value. Counter 207 generates a sawtooth wave by repeating an operation of counting a predetermined count number and resetting the count value to the minimum count value when the count value exceeds the maximum count value at cycle T.

Further, counter 207 may generate a sawtooth wave by repeating an operation of resetting the count value to the maximum count value when the count value decremented from the maximum count value becomes less than the minimum count value.

For example, when the minimum count value is 0 and the maximum count value is 999 with a 100 MHz clock, the cycle T is a constant cycle of 10 usec (100 kHz). The count value is repeated for 1,000 counts (count numbers) from the minimum count value 0 to the maximum count value 999.

PWM setter 203 converts the command value into an on-count value (dotted line) corresponding to the count number of cycle T.

For example, in a case where the command value is 0.5, 1,000×0.5=500, which obtained by multiplying 1,000 by the command value, is the on-count value. A pulse waveform with a duty ratio of 0.5 is obtained by setting the on-period as a period of 500 counts out of 1,000 counts, e.g., a period of counting to 500 in a period of counting from the minimum count value 0 to the maximum count value 999.

Comparator 208 generates a PWM wave by setting the output to H (on) at the counter reset timing and setting the output to L (off) at the timing when the count value exceeds the on count value.

Note that in a case where a sawtooth wave generated by decrementing the count value is used, a PWM wave may be generated by comparator 208 by setting the output to H (on) at the counter reset timing and setting the output to L (off) at the timing when the count value becomes less than the on count value.

By repeating this operation, a PWM wave is generated for each constant cycle T.

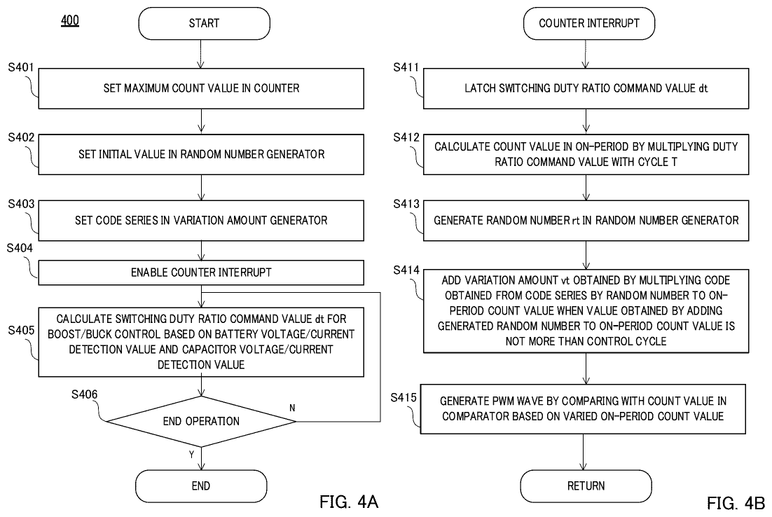

Generation of the boost/buck control PWM signal is described with reference to FIGS. 4A and 4B. In FIGS. 4A and 4B, S represents a step. FIG. 4A illustrates an example of a main routine for the boost/buck control, and FIG. 4B illustrates an example of a counter interrupt routine to interrupt each time the counter is reset. The main routine and the counter interrupt routine may be constituted by a program to be executed by a processor.

In S401 of FIG. 4A, for example, boost/buck controller 202 or PWM setter 203 sets cycle T or the maximum count value corresponding to cycle T in counter 207.

In S402, for example, PWM setter 203 sets an initial value for random number generation in random number generator 204.

In S403, for example, PWM setter 203 sets the control cycle (predetermined interval) of the variation amount and the code series in variation amount generator 205.

After performing these initial settings in S401 to S403, boost/buck controller 202 operates counter 207 in S404 to start the counter interrupt routine and enables the counter interrupt, for example.

In S405, for example, boost/buck controller 202 calculates the switching duty ratio for the boost/buck control based on the battery voltage/current detection value and the capacitor voltage/current detection value, and calculates the command value.

In S406, for example, boost/buck controller 202 confirms whether an operation end command has been received from another controller.

In a case where the boost/buck controller 202 receives the operation end command (S406: Yes), the flow ends.

In a case where boost/buck controller 202 has not received the operation end command (S406: No), the flow returns to S405, and the boost/buck control is repeated.

When a counter interrupt occurs due to the counter reset timing from counter 207 during the execution of S405, the counter interrupt routine is activated and executed from S411 in FIG. 4B.

In S411 of FIG. 4B, for example, PWM setter 203 latches (holds) the current command value (switching duty ratio).

In S412, for example, PWM setter 203 converts the command value into an on-count value (initial threshold value) corresponding to the on-period of a PWM wave with a cycle T (count number).

In S413, for example, random number generator 204 generates a random number value and updates the random number series.

In S414, for example, variation amount generator 205 determines whether the value obtained by multiplying the updated random number series by the code series and adding the result to the on-count value is equal to or less than the minimum count value or equal to or greater than the maximum count value. In a case where the added value is equal to or less than the minimum count value or equal to or greater than the maximum count value, variation amount generator 205 sets the variation amount to zero. In a case where the added value is between the minimum count value and the maximum count value, variation amount generator 205 sets the variation amount by multiplying the generated random number by the current code of the code series, and outputs the variation amount to adder 206. Adder 206 adds the set variation amount to the on-count value to generate a variation on-count value.

Further, adder 206 may add the variation amount to the count value instead of adding the variation amount to the on-count value. The output of adder 206, into which the count value output from counter 207 and the variation amount output from variation amount generator 205 are input, and the on-count value output from PWM setter 203 may be input to comparator 208. Counter 207 may count, for example, 1,000 counts of count values from 50 to 1,049 or 1,000 counts of count values from −30 to 969 instead of counting from 0 to 999.

In S415, for example, adder 206 outputs (sets) the variation on-count value generated in S414 to comparator 208, and comparator 208 compares the variation on-count value generated by adder 206 with the count value input from counter 207 to generate a PWM wave. When PWM generator 209 generates a PWM wave (the PWM waveform becomes the L level), the process returns from the counter interrupt routine. Alternatively, in a case where counter 207 and comparator 208 are implemented in parallel with hardware or the like, the process returns from the counter interrupt routine at the time when the variation on-count value is set.

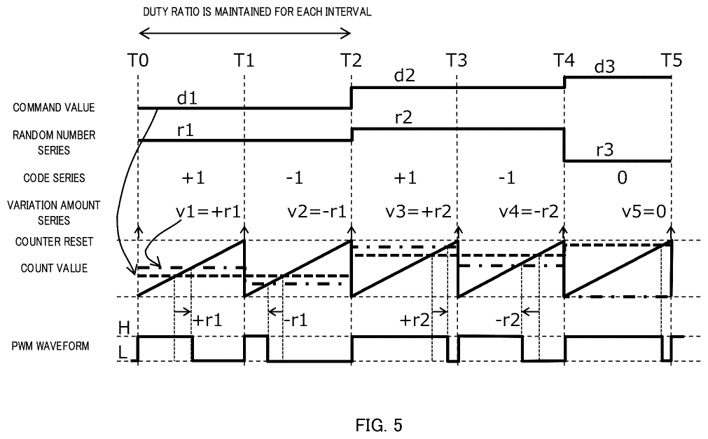

Spectrum spread PWM signal generation will be described with reference to FIG. 5.

The generation of the PWM wave is the same as the basic operation described in FIG. 3, but in order to vary the on-period of the PWM wave, one of the inputs of comparator 208 is changed from the on-count value (dotted line) to the variation on-count value (one-dot chain line) using a random number series and a code series.

Here, an example in which the command value commanded by the boost/buck controller 202 is updated once every two cycles will be described. In this example, the control cycle is 2T, and the on-period of the PWM wave is varied using a basic code series of length 2 {+1, −1}.

The command value represents the duty ratio as a real number between 0.0 and 1.0, and represents the ratio of the period in which a predetermined switch of DCDC converter circuit 103 is turned on within cycle T.

The random number series is updated according to the length of the basic code series corresponding to the control cycle. In a case where a basic code series of length 2 {+1, −1} is used, the random number series is basically updated once every 2 cycles, and the random number series rₖ={r1, r1, r2, r2 . . . } results.

The code series is a series in which the selected basic code series is repeated, and in a case where the basic code series of length 2 {+1, −1} is selected, the series is {+1, −1, +1, −1 . . . }.

The variation amount series is generated by multiplying each element of the random number series by each element of the code series. For example, each element of random number series rₖ={r1, r1, r2, r2 . . . } is multiplied by each element of code series sₖ={+1, −1, +1, −1 . . . } to generate variation amount series vₖ={+r1, −r1, +r2, −r2 . . . }.

FIG. 5 illustrates an example in which the random number series is in units of the control cycle (2T), but the present disclosure is not limited thereto, and the random number series may be in units of a period other than the control cycle (2T). For example, the random number series may be in units of an integer multiple of the control cycle (n×2T). Further, the update timing of the command value and the start timing of the random number series may be different. Further, the timing of the update of the command value and the timing of the PWM wave generation (the rising timing of the PWM wave) may be different. For example, in a case where the command value is updated between T0 and T1, T1 may be the start timing of the on-count value. Further, the variation amount may be in real number units instead of count value (integer) units. In a case where the variation amount is a real number, the average of a plurality of variation amounts may be considered as the variation amount in consideration of the fractional part below the decimal point in another cycle. In a case where the variation amount is +50.5 or −50.5, the average may be +50.5 or −50.5 by setting the variation amounts to +50, −50, +51, and −51.

Note that in a case where the range of the count value of cycle T is exceeded when the variation amount is added to the on-count value, the variation amount is set to 0. For example, in a case where the maximum count value is exceeded when the variation amount (for example, r3) is added to the on-count value at time point T4, or in a case where the value becomes equal to or less than the reset value (minimum count value) when the variation amount (for example, −r3) is added to the on-count value at time point T5 (r3 is subtracted), the random number r3 is set to 0 (the variation amounts v5 and v6 are set to 0) while maintaining the control cycle of the code series. In this case, variation amount series vₖ is vₖ={+r1, −r1, +r2, −r2, 0, 0, +r4, −r4 . . . }.

Alternatively, in the above case, random number value r3 may be set to 0 in any one cycle. In this case, variation amount v5 may be set to 0, the random number series and the code series may be updated with v6, and variation amount series vₖ may be set as vₖ={+r1, −r1, +r2, −r2, 0, +r4, −r4 . . . }.

Counter 207 increments the count value with the clock cycle from oscillation circuit 201. Counter 207 outputs a sawtooth wave by repeating an operation of resetting the count value at the maximum count value corresponding to cycle T.

For example, when 1,000 counts are set in the period during which the minimum count value is 0 and the maximum count value is 1,000 (the count value is from 0 to 999) with a 100 MHz clock, the cycle T is 10 usec (100 kHz).

PWM setter 203 converts the command value into an on-count value (dotted line) corresponding to the count number of cycle T.

The variation on-count value (one-dot chain line) is obtained by adding variation amount series vₖ to the on-count value (dotted line). By setting the variation on-count value as a threshold value in comparator 208, PWM generator 209 can generate a PWM wave in which the on-period is randomly varied while maintaining the duty ratio of the command value in the control cycle.

For example, in a case where the command value is 0.5, 1,000×0.5=500, which obtained by multiplying 1,000 by the command value, is the on-count value. When, for example, variation amount series vₖ={+10, −10, +25, −25 . . . } is added to this, the variation on-count value becomes {510, 490, 525, 475 . . . }. When this variation on-count value is used, PWM generator 209 outputs a pulse waveform in which a duty ratio of 0.5 is maintained in a control cycle for every two cycles. In a case where the on-count value is not an integer, the average of a plurality of cycles may be set as the on-count value. For example, in a case where the on-count value based on the command value is 500.5, the average on-count value may be 500.5 by using the on-count value 500 and then using the on-count value 501. Thus, it is possible to control the duty ratio more finely.

The PWM wave is generated by comparator 208 by setting the output to H (on) for the count value equal to or less than the threshold value (variable on-count value) and setting the output to L (off) for the count value greater than the threshold value. The PWM wave may be generated by comparator 208 by setting the output to L (off) for the count value equal to or less than the threshold value (variation on count value), and setting the output to H (on) for the count value greater than the threshold value.

An example of the operation at each time point will be described as follows. Time point T0: The command value is latched, and d1 is held. d1 is multiplied by the count number to convert it into on-count value D1. The random number series is updated, and random number value r1 is held from random number series {r1, r1, r2, r2 . . . }. If D1+r1 exceeds the maximum count value or D1−r1 is less than the minimum count value, v1 is set to 0. Otherwise, +1 is extracted from the code series {+1, −1, +1, −1 . . . } and is multiplied by random number value r1 to make variation amount v1=+r1. The variation on-count value vD1=D1+v1=D1+r1 is set as the threshold value of the comparator. A PWM wave in which L (off) is set when the count value exceeds vD1 is generated, with the on-period extended by r1 from the original on-period.

Time point T1: Held command value d1 (on-count value D1) and random number value r1 are used. If D1+r1 exceeds the maximum count value or D1−r1 is less than the minimum count value, v2 is set to 0. Otherwise, −1 is taken out from code series {+1, −1, +1, −1 . . . } and is multiplied by random number value r1 to make variation amount v2=−r1. The variation on-count value vD2=D1+v2=D1−r1 is set as the threshold value of the comparator. A PWM wave in which L (off) is set when the count value exceeds vD2 is generated, with the on-period shortened by r1 from the original on-period.

Time point T2: The command value is latched, and d2 is held. The d2 is multiplied by the count number to convert it into on-count value D2. The random number series is updated, and random number value r2 is held in the random number series {r1, r1, r2, r2 . . . }. If D2+r2 exceeds the maximum count value or D2−r2 is less than the minimum count value, v3 is set to 0. Otherwise, +1 is extracted from the code series {+1, −1, +1, −1 . . . } and is multiplied by random number value r2 to make variation amount v3=+r2. The variation on-count value vD3=D2+v3=D2+r2 is set as the threshold value of the comparator. A PWM wave in which L (off) is set when the count value exceeds vD3 is generated, with the on-period extended by r2 from the original on-period.

Time point T3: Held command value d2 (on-count value D2) and random number value r2 are used. If D2+r2 exceeds the maximum count value or D2−r2 is less than the minimum count value, v4 is set to 0. Otherwise, −1 is taken out from code series {+1, −1, +1, −1 . . . } and is multiplied by random number value r2 to make variation amount v4=−r2. The variation on-count value vD4=D2+v4=D2−r2 is set as the threshold value of the comparator. A PWM wave in which L (off) is set when the count value exceeds vD4 is generated, with the on-period shortened by r2 from the original on-period.

Time point T4: The command value is latched, and d3 is held. The d3 is multiplied by the maximum count value to convert it into on-count value D3. The random number series is updated, and random number value r3 is held. In this example, since D3+r3 exceeds the maximum count value, the variation amount v5 is set to 0. The variation on-count value vD5=D3+v5=D3 is set as the threshold value of the comparator. A PWM wave in which L (off) is set when the count value exceeds vD5 is generated, with the on-period being the same as the original on-period. Since this case assumes that the variation amount v3=0 in one cycle (T4 to T5), the latch of the command value and the update of the random number series are performed at T5 as at time points T0 and T2.

In a case where the control cycle length of the code series is maintained and two cycles v5=v6=0 are set, the same operation as at time point T4 is performed at time point T5.

By repeating these operations, it is possible to hold the duty ratio for each control cycle (2T) and to vary the on-period of each PWM wave without changing the cycle T of the PWM wave generation, in a constant cycle T.

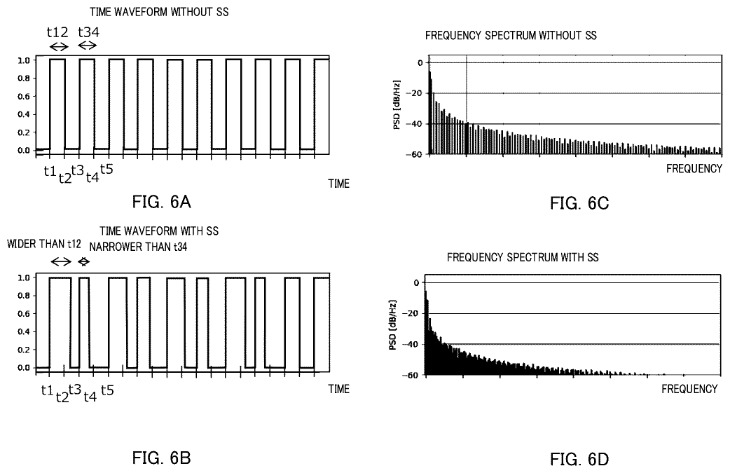

A spectrum of a PWM wave will be described with reference to FIGS. 6A to 6D. Here, an example of a duty ratio of 50% (the ratio of the on-period to the off period is the same) will be described.

FIGS. 6A and 6C illustrate cases without SS, and FIGS. 6B and 6D illustrate cases with SS according to the present disclosure. FIGS. 6A and 6B illustrate time waveforms of PWM waves (the horizontal axis represents time, and the vertical axis represents amplitude level), and FIGS. 6C and 6D illustrate frequency spectra of PWM waves (the horizontal axis represents frequency, and the vertical axis represents power spectral density [dB/Hz]).

When viewed on the time axis, the PWM wave in FIG. 6B repeats a PWM wave with a long on-period and a PWM wave with a short on-period every two cycles compared to FIG. 6A. For example, the PWM wave in the odd-numbered cycle has an on-period longer than the on-period (t12) in FIG. 6A, and the PWM wave in the even-numbered period has an on-period shorter than the on-period (t34) in FIG. 6A, and the variation width changes every two cycles.

In FIG. 6C, the PWM wave without SS has a high level of higher harmonics of the PWM wave, but as shown in FIG. 6D, it can be seen that by performing SS of the present disclosure the energy of the frequency of the line spectrum is dispersed (the gap is filled) and the level of the higher harmonics is reduced.

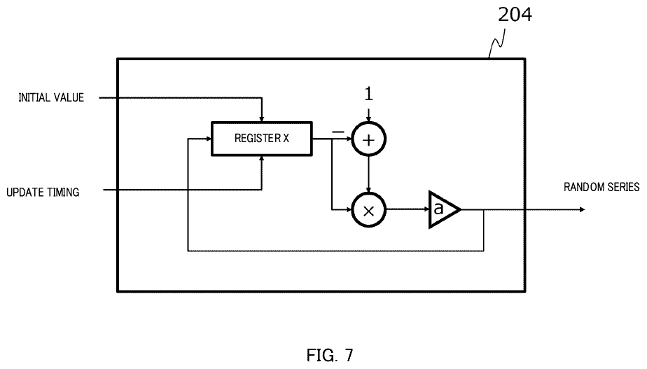

A random number generator will be described with reference to FIG. 7.

Random number generator 204 generates a random number series based on the update timing from PWM setter 203 after the initial value is set, and outputs the random number to variation amount generator 205.

FIG. 7 illustrates a random number generator using a logistic map that can generate a series with complexity in a simple configuration as an example. Note that a random number series may be generated by a method other than the logistic map.

The logistic map is represented by a difference equation of xₙ₊₁=axₙ(1.0−xₙ). When parameter a and an initial value x₀ are provided, it generates a series xₙ that exhibits non-periodic variations called chaos, with complexity depending on parameter a.

The logistic map can generate a complex random series in the range of xₙ=[0.0, 1.0] when a=4.0 and 0<x₀<1.

When an initial value 0.0<x₀<1.0 and parameter a (=4.0) are set in the random number generator and register X is updated at each update timing, a random series is generated.

The output value is normalized to be within a predetermined range and is used as a variation amount.

Note that in the case of a=4.0, the occurrence frequency of xₙ generated in the range of [0.0, 1.0] near 0 and near 1 is high. Therefore, a random number may be generated by adopting that value in the case of a predetermined range, e.g., 0.1<xₙ<0.9, and by re-updating and obtaining a new xₙ in other cases.

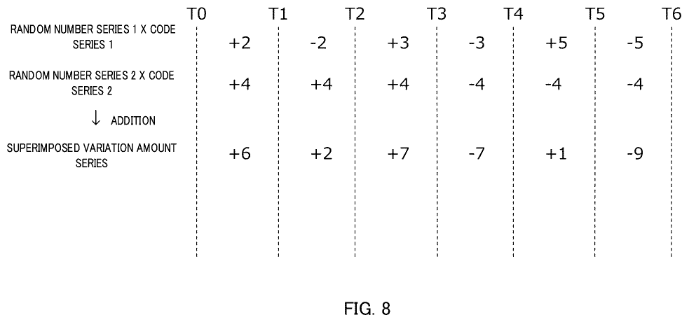

A superimposed variation amount series will be described with reference to FIG. 8. Here, an example of generating a new variation amount series by superimposing code series with different control cycle lengths will be described.

Code series 1 is repeated with {+1, −1} to maintain the duty ratio in a control cycle of 2T.

By multiplying code series 1 by random number series 1 {r1_1, r1_1, r1_2, r1_2, r1_3, r1_3}, variation amount series 1 {+r1_1, −r1_1, +r1_2, −r1_2, +r1_3, −r1_3} is generated.

On the other hand, code series 2 is repeated as {+1, +1, +1, −1, −1, −1} to maintain the duty ratio in a control cycle of 6T.

By multiplying code series 2 by random number series 2 (r2_1, r2_1, r2_1, r2_1, r2_1, r2_1), variation amount series 2 {+r2_1, +r2_1, +r2_1, −r2_1, −r2_1, −r2_1} is generated.

By superimposing (adding) variation amount series 1 and variation amount series 2, superimposed variation amount series {+r1_1+r2_1, −r1_1+r2_1, +r1_2+r2_1, −r1_2−r2_1, +r1_3−r2_1, −r1_3 −r2_1} is generated. By using the superimposed variation amount series, it is possible to give the PWM wave a variation with increased randomness.

FIG. 8 illustrates the first six cycles in an example where random number series 1 is {2, 2, 3, 3, 5, 5}, code series 1 is {+1, −1}, random number series 2 is {4, 4, 4, 4, 4, 4}, and code series 2 is {+1, +1, +1, −1, −1, −1}. By multiplying random number series 1 and code series 1, variation amount series 1 {+2, −2, +3, −3, +5, −5} is generated, and by multiplying random number series 2 and code series 2, variation amount series 2 {+4, +4, +4, −4, −4, −4} is generated. By adding variation amount series 1 and variation amount series 2, superimposed variation amount series {+6, +2, +7, −7, +1, −9} is generated.

Note that in this example, the start (phase) of the control cycles of the two variation amount series is aligned, but the start of the two variation amount series may be misaligned. For example, variation amount series 1 may be started from T0, while variation amount series 2 may be started from T1. Further, three or more variation amount series may be superimposed.

In a case where the variation in the command value is gradual and the period of the steady state is long, the duty ratio of the PWM wave is substantially preserved even when a code series with a long control cycle length is used.

### Effect of Embodiment 1

According to Embodiment 1, the counter performs a reset for each constant cycle, enabling software control in which the generation processing time does not vary. Further, by generating a PWM wave based on the variation amount, it is possible to generate a spectrum-spread PWM wave. Further, by generating the variation amount such that the sum of the variation amounts is 0 for each control cycle including two or more constant cycles, it is possible to improve the spectrum spreading effect while easily maintaining the duty ratio for each control cycle. Further, in a case where the value obtained by adding the variation amount and the threshold value is greater than the maximum count value of the counter or is less than the minimum count value, the variation amount is set to 0, thereby ensuring that the duty ratio for each control cycle is reliably maintained. Further, a random number is easily generated by the logistic map. Further, by superimposing two or more variation amount series each having a different control cycle, a PWM wave in which the energy of the frequency of the line spectrum is more appropriately dispersed is generated.

### Embodiment 2

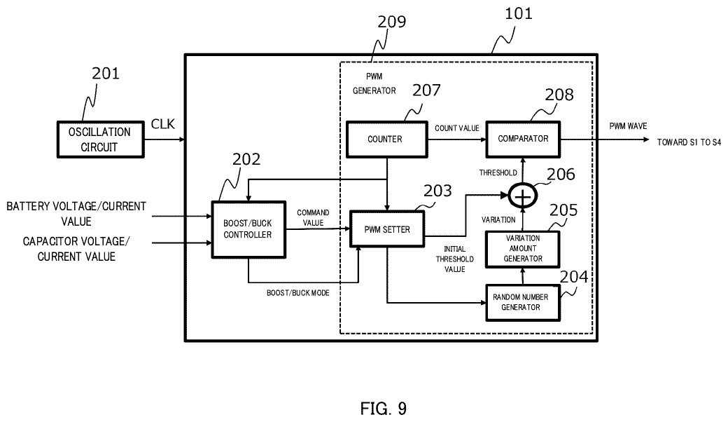

Embodiment 2 differs from Embodiment 1 in that boost/buck controller 202 in FIG. 9 inputs the control mode of the boost/buck to PWM setter 203.

When the variation period of the command value (whether the variation is gradual or rapid) changes depending on the control mode of the boost/buck, PWM setter 203 may change the control cycle length (predetermined interval length) accordingly.

For example, in a case of controlling at a high speed in a short period, a short (for example, 2T) control cycle is used. In a case where the control is performed gently over a long period of time, such as in a steady state with relatively little change, a long (for example, 6T) control cycle may be used, and the randomness of spectrum spreading may be enhanced by using a multi-period superimposed series.

For this reason, boost/buck controller 202 inputs information on the current control mode of the boost/buck to PWM setter 203. PWM setter 203 can change the control cycle, the period of the random number generation (update) timing (the frequency of the random number generation), and the like based on the control mode input from the boost/buck controller 202.

### Effect of Embodiment 2

According to Embodiment 2, a PWM wave in which spectrum spreading is performed in accordance with the control mode of the boost/buck is generated.

In the above-mentioned embodiment, the notation “ . . . part” used for each component may be replaced by other notations such as “ . . . circuitry,” “ . . . assembly,” “device,” “ . . . unit,” or “ . . . module.”

The above description of the embodiments is with reference to the drawings, but the present disclosure is not limited to such examples. It is clear that one skilled in the art can conceive of various examples of changes or modifications within the scope of the claims. It is understood that such changes or modifications also fall within the technical scope of the present disclosure. In addition, each component of the embodiment may be arbitrarily combined to the extent that the intent of the present disclosure is not departed from.

This disclosure can be realized by software, hardware, or software in conjunction with hardware. Each functional block used in the description of the above embodiments may be partially or entirely realized as an LSI, an integrated circuit, and each process described in the above embodiments may be partially or entirely controlled by a single LSI or a combination of LSIs. The LSI may be composed of individual chips or may be composed of a single chip to include some or all of the functional blocks. The LSI may have data inputs and outputs. LSIs may be referred to as ICs, system LSIs, super LSIs, or ultra LSIs, depending on the degree of integration.

The method of integrated circuitry is not limited to LSI, but may be realized with dedicated circuits, general-purpose processors or dedicated processors. Field Programmable Gate Array (FPGA), which can be programmed after LSI manufacturing, and reconfigurable processors, which can reconfigure the connections and settings of circuit cells inside the LSI, may also be used. This disclosure may be realized as digital or analog processing.

Furthermore, if a technology for integrated circuits replacing LSI appears due to advances in semiconductor technology or another derived technology, the technology may naturally be used to integrate functional blocks. The application of biotechnology, etc. may be a possibility.

This application is entitled to and claims the benefit of Japanese Patent Application No. 2022-119572 filed on Jul. 27, 2022, the disclosure each of which including the specification, drawings and abstract is incorporated herein by reference in its entirety.

### INDUSTRIAL APPLICABILITY

The embodiment of the present disclosure is useful for a switching power supply system.

### REFERENCE SIGNS LIST

101 CPU
102 Battery
103 DCDC converter (boost/buck) circuit
104 Capacitor
201 Oscillation circuit
202 Boost/buck controller
203 PWM setter
204 Random number generator
205 Variation amount generator
206 Adder
207 Counter
208 Comparator

1. A pulse width modulation wave generation device comprising:
a counter circuit that generates a count value that is reset for each constant cycle;
a threshold value generation circuit that generates an initial threshold value;
a variation amount generation circuit that generates a variation amount such that a sum of variation amounts for each control cycle including two or more of the constant cycles is 0; and
a comparison circuit that compares a value based on the count value with a threshold value based on the initial threshold value and generates a pulse width modulation wave based on the variation amount.

2. The pulse width modulation wave generation device according to claim 1, wherein:
the value based on the count value is the count value; and
the threshold value based on the initial threshold value is a value obtained by adding the variation amount to the initial threshold value.

3. The pulse width modulation wave generation device according to claim 1, wherein:
the value based on the count value is a value obtained by adding the variation amount to the count value; and
the threshold value based on the initial threshold value is the initial threshold value.

4. The pulse width modulation wave generation device according to claim 1, further comprising:
a random number generation circuit that generates a random number for each control cycle, wherein:
the variation amount generation circuit generates a variation amount series by using the random number and a basic code series whose sum is 0 for each control cycle; and
the variation amount is set to 0 when a value obtained by adding the variation amount of the variation amount series and the threshold value is greater than a maximum count value of a counter or is less than a minimum count value of the counter.

5. The pulse width modulation wave generation device according to claim 4, wherein:
the random number generation circuit generates a random number by using a logistic map (xₙ₊₁=axₙ(1.0−xₙ)).

6. The pulse width modulation wave generation device according to claim 4, wherein:
the variation amount is generated by superimposing two or more variation amount series having different control cycles.

7. A direct current to direct current converter control device, comprising:
the pulse width modulation wave generation device according to claim 1, wherein:
a direct current to direct current converter circuit is controlled based on the pulse width modulation wave.

8. A direct current to direct current converter control device, comprising:
the pulse width modulation wave generation device according to claim 4, in which the variation amount series is changed in accordance with a change in a boost/buck control mode, wherein:
a direct current to direct current converter circuit is controlled based on the pulse width modulation wave.

9. A direct current to direct current converter comprising:
the direct current to direct current converter control device according to claim 7; and
the direct current to direct current converter circuit.

10. A pulse width modulation wave generation method, comprising:
generating a count value that is reset for each constant cycle;
generating an initial threshold value;
generating a variation amount such that a sum of variation amounts for each control cycle including two or more of the constant cycles is 0; and
comparing a value based on the count value with a threshold value based on the initial threshold value, and generating a pulse width modulation wave based on the variation amount.

11. A direct current to direct current converter control method, comprising: controlling a direct current to direct current converter based on the pulse width modulation wave obtained by the pulse width modulation wave generation method according to claim 10.

12. A non-transitory computer readable medium which stores a program that causes a processor to execute the pulse width modulation wave generation method according to claim 10.
